(19) United States
(12) Patent Application Publication
(10) Pub. No.: US 2008/0031593 A1
(43) Pub. Date: Feb. 7, 2008

(54) Multi-layer structure unit for recording audio/video frame data and its operation method

(76) Inventors: Shih-Fang Chuang, Hsinchu (TW); Ching-Huei Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/499,733

(22) Filed: Aug. 7, 2006

(51) Int. Cl. H04N 7/00

(52) U.S. Cl. 386/95

(57) ABSTRACT

A multi-layer structure unit of recording AV frame data includes a general control layer, a task control layer and a movie-format control layer. The general control layer is used to control a compression process of AV frame data, and manage a circular queue. The task control layer includes a plurality of control units, and is used to execute the necessary task of recording AV frame data with accessing the circular queue. Finally, the movie-format control layer is used for building a file with AV frame data. Hence, the multi-layer structure unit of recording AV frame data can improve the extensibility, the maintenance and the readability of software program.

### BACKGROUND OF THE INVENTION

1. Field of the Invention

The present invention relates to a multi-layer structure unit and its operating method, and more particularly to a multi-layer structure unit for recording audio/video frame data and its operating method.

2. Description of Related Art

As science and technology advance, the functions of mobile phones available in the market become increasingly powerful, and many multimedia functions are integrated to increase the add-on values of mobile phones to attract consumer's attentions. Further, a charge-coupled device is also used for a dynamic recording function, in addition to its original function of integrating a digital camera into a mobile phone.

In a prior art, a firmware structure used for processing the dynamic recording function is a single-layer design that integrates the control of all general control programs, specific executed programs and file formats into the same procedure of the control architecture and uses a linear shared-queue to temporarily store the data and execute the bottom-layer data.

In this design, the software program is custom-made, and thus it will go through a larger change if it is necessary to make a modification. Furthermore, the modification cannot be made easily due to the low extensibility of the program, and the maintenance of the saved file formats are more complicated, and thus the readability of the whole program is very low. Regardless of adding a new function or maintaining existing functions, it is necessary to modify the whole software architecture, bringing tremendous inconvenience to the development of software. As to the temporary storage and execution of the bottom-layer data, the efficiency for writing files is low, and the speed of saving files is restricted, since a linear structure is adopted for the queue.

### SUMMARY OF THE INVENTION

In view of the foregoing shortcomings, the present invention provides a multi-layer structure unit for recording audio/video frame data and its operating method, and the software architecture of the invention can improve the extensibility, maintenance and readability and enhance the performance of the execution of the software program.

To overcome the foregoing problems of the prior art, a solution of the present invention provides a multi-layer structure unit for recording audio/video frame data that comprises: a general control layer, a task control layer and a movie-format control layer. The general control layer is provided for controlling a compression process of the audio/video frame data and managing a circular queue, and the task control layer includes a plurality of control units for executing a task as well as accessing the circular queue required for recording the audio/video frame data. At least one movie-format control unit in the movie-format control layer is used for creating a file from the audio/video frame data.

To overcome the foregoing shortcomings, another solution of the present invention provides a method for operating a multi-layer structure unit for recording audio/video frame data that comprises the steps of: receiving an audio/video frame data, and executing a task of compressing the audio/video frame data, setting a buffer which has been set to a blank status in a circular queue to a write status, and compressing the audio/video frame data into the buffer; determining whether or not the buffer is filled up, setting the status of the buffer to a fill-up status and setting another buffer to a blank status if the buffer is filled up, using a write file task to detect the fill-up status and setting the buffer to a read status, reading a plurality of compressed audio/video frame data temporarily stored in the buffer, and creating a movie-format file by the compressed audio/video frame data.

To overcome the foregoing problems, another solution of the present invention provides a method for a task of compressing audio/video frame data. The method is an interlace compression method applied to the operation of a multi-layer structure unit for recording audio/video frame data, and the method comprises the steps of: waiting for an image change event and determining whether or not the multi-layer structure unit is situated at a recording status; determining whether or not an image frame data exists in a buffer in a circular queue if the determined result of the recording status is yes, and compressing a sound frame data if the determined result of the image frame data is yes, or else setting the size of a sound frame data; determining whether or not the buffer is filled up; setting the buffer to a fill-up status and obtaining a butter which is set to a blank status if the determined result is yes; setting the size of a sound frame data; directly setting the size of the sound frame data if the buffer is determined as not filled up; compressing an image frame data and updating a recording information after the size of the sound frame data is set. By repeating the foregoing steps, the invention can compress the image frame data and the sound frame data into the buffer, so as to complete the interlace compression method.

To make it easier for our examiner to understand the innovative features and technical content, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic view of a multi-layer structure unit for recording audio/video frame data according to a preferred embodiment of the present invention;

FIG. 2 is a schematic view of a method of operating a multi-layer structure unit for recording audio/video frame data according to a preferred embodiment of the present invention;

FIG. 3 is a flow chart of a multi-layer structure unit for recording audio/video frame data according to a preferred embodiment of the present invention;

FIG. 4 is a schematic view of the structure of a circular queue applied in the present invention; and

FIG. 5 is a flow chart of a task of compressing audio/video frame data according to the present invention.

### DETAILED DESCRIPTION OF THE PREFERRED EMBODIMENTS

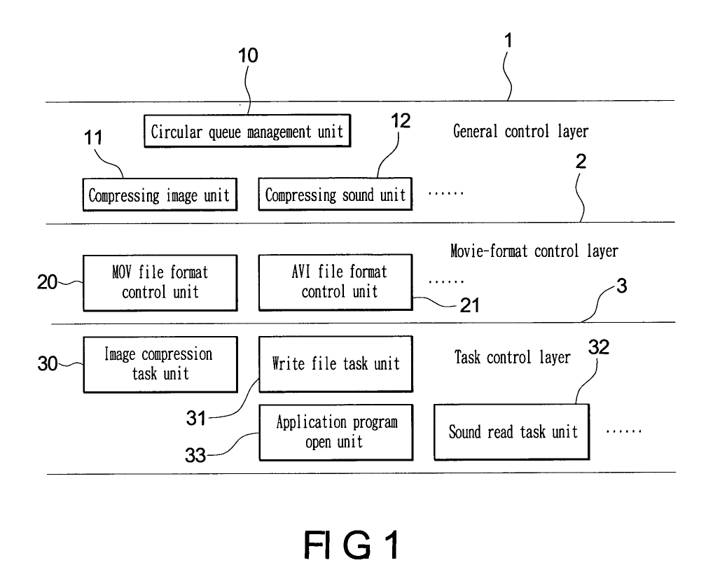

Referring to FIG. 1 for a schematic view of a method of operating a multi-layer structure unit for recording audio/video frame data according to a preferred embodiment of the present invention, the multi-layer structure unit comprises: a general control layer 1, a movie-format control layer 2 and a task control layer 3. The general control layer 1 further comprises a circular queue management unit 10, a compressing image unit 11 and a compressing sound unit 12 for controlling a compression process of the audio/video frame data and managing a circular queue, and the units in the general control layer 1 are all public control programs used for controlling the normal procedure for compressing the audio/video frame data, and the procedure will not vary according to different special cases.

The task control layer 3 comprises a plurality of control units including but not limited to an image compression task unit 30, a write file task unit 31, a sound read task unit 32 and an application program open unit 33 that access and operate with the data temporarily stored in the circular queue to execute the task for recording the audio/video frame data. The movie-format control layer 2 includes at least one movie-format control unit including but not limited to an AVI file format control unit 21 or a MOV file format control unit 20 for creating a file from the audio/video frame data.

The control programs of all units in the movie-format control layer 2 and the task control layer 3 are independent modules, and thus they can be added or maintained separately according to different special cases.

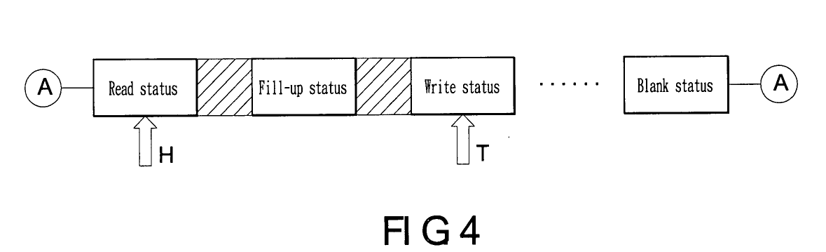

Referring to FIG. 4 for a schematic view of the architecture of a circular queue used in the invention, the circular queue includes a plurality of buffers for temporarily storing data, and the buffers are controlled by a head index H and a tail index T, and the status of all buffers could be a blank status, a write status, a fill-up status and a read status. The buffers have a uniform memory size for improving the efficiency of the program to access the buffers. Further, the head index is operated and used when a write file task unit 31 in the task control layer 3 executes the write file task, and the tail index is operated and used when an image compression task unit 30 of the task control layer 3 executes a task for compressing audio/video frame data.

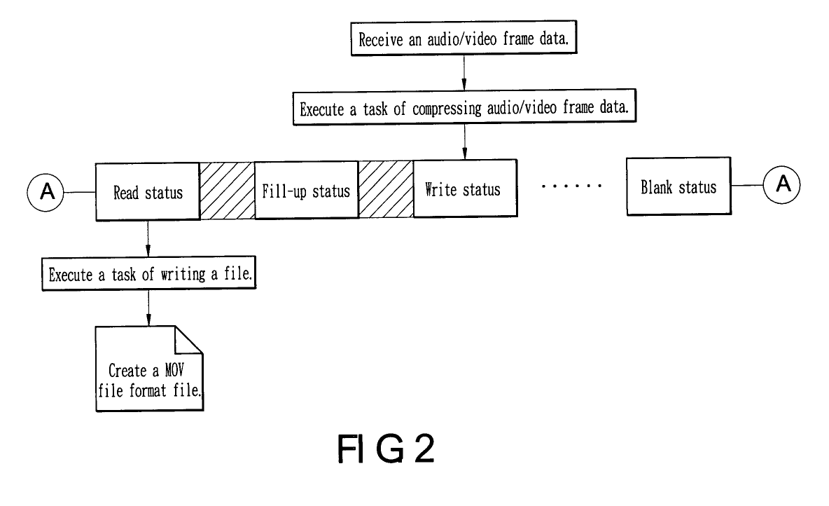

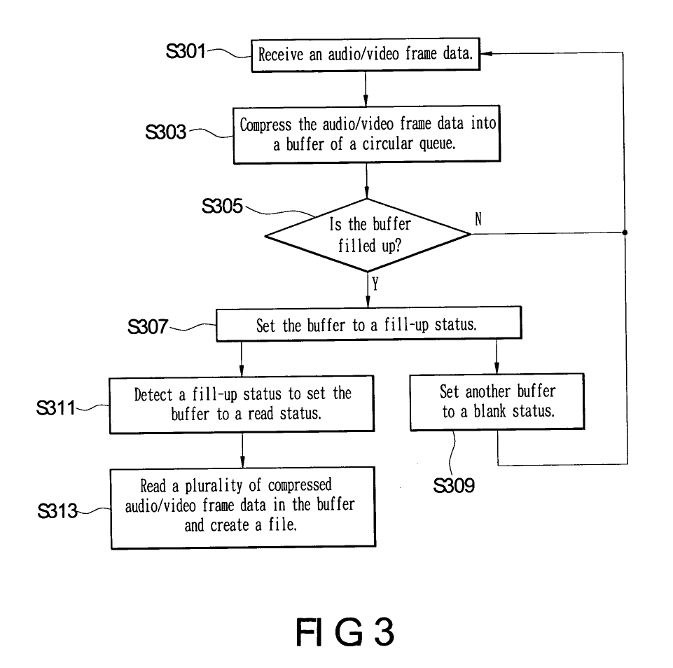

Referring to FIGS. 2 and 3 for a schematic view and a flow chart of a multi-layer structure unit for recording audio/video frame data in accordance with a preferred embodiment of the present invention, the invention provides a method for operating a multi-layer structure unit for recording audio/video frame data. The method comprises the steps of receiving an audio/video frame data (S301), using an image compression task unit 30 of a task control layer 3 to execute a task of compressing audio/video frame data and set a buffer which has been set to a blank status in a circular queue to a write status and compressing the received audio/video frame data into a buffer (S303), wherein the task for compressing audio/video frame data is carried out by an interlace compression method that compresses images first and then compresses sounds; determining whether or not the buffer is filled up (S305); setting the buffer to a fill-up status (S307) if the determined result is yes, and setting another buffer to a blank status (S309); and continuing the Step (S301) to receive an audio/video frame data if the determined result is no or after the Step (S309).

During the Step (S309), a write file task unit 31 in the task control layer 3 sets a buffer to a read status after a write file task detects a buffer which is set to a fill-up status (S311), and reads a plurality of compressed audio/video frame data temporarily stored in a buffer which has been set to a read status, and creates a movie-format file by the compressed audio/video frame data (S313), wherein the movie-format could be an AVI file format or a MOV file format.

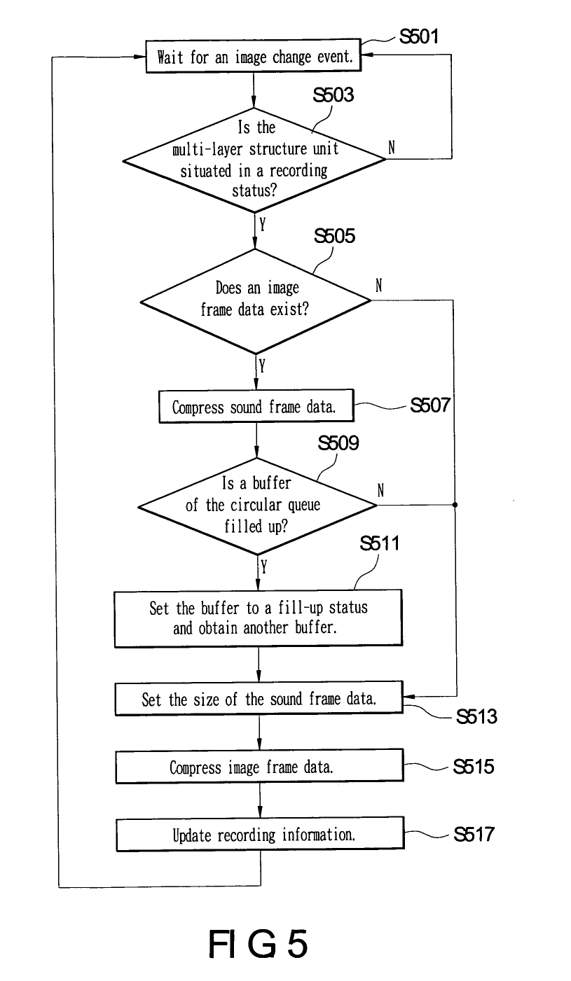

Referring to FIG. 5 for a flow chart of a task of compressing audio/video frame data according to the present invention, the invention provides a method for compressing audio/video frame data, and the method is an interlace compression method that compresses images first and then compresses sounds. The method applied to the operation of a multi-layer structure unit for recording audio/video frame data comprises the steps of: waiting for an image change detected by a charge-coupled device (CCD) to produce an interrupt signal to trigger an image change event (S501); determining whether or not the multi-layer structure unit for recording audio/video frame data is situated at a recording status (S503); determining whether or not an image frame data exists in a buffer in a circular queue if the determined result of the recording status is yes (S505), and the status of this buffer is in a write status; in the other hand, continuing to wait for an image change event as described in Step (S501) if the determined result of Step (S503) is no.

The buffer does not have any image frame data for the first time when the determined result is obtained in Step (S505), and thus if the determined result is no, the Step (S513) is used to directly set the size of the sound frame data, and the compressing image unit 11 in the general control layer 1 is used to compress an image frame data into the buffer (S515) to make it as the first record of image frame data, and update the recording information (S517). The application program open unit 33 in the task control layer 3 executes a task for opening an application program interface to provide related recording information (such as the remaining recording time, or a recording error) to a previous user interface (UI).

If an image change is detected again, the determined result of the existence of image frame data as described in Step (S505) will be yes, and a compressing sound unit 12 in the general control layer 1 will compress a sound frame data (S507) into the buffer based on the previously set size of the sound frame data, and determine whether or not the buffer is filled up (S509). If the determined result is yes, then the buffer will be set to a fill-up status, and another buffer which is set to a blank status will be obtained (S511) to continue a task for compressing audio/video frame data.

If the determined result of Step (S509) is no or after Step (S511), the size of the sound frame data will be set first (S513), and the image frame data will be compressed (S515), and finally the recording information will be updated (S517). By repeating the foregoing steps, the invention compresses the image frame data and the sound frame data into the buffer by an interlace compression method, so that an image compression task unit 30 in a task control layer 3 executes the task of compressing audio/video frame data.

In summation of the description above, the technical measures taken by the invention provides an improved software architecture, not only improving the extensibility, maintenance and readability of the software programs, but also enhancing the performance of executing the software program. The invention also has the following advantages:

1. The invention reduces unnecessary waste of memories. The circular queue is used as a buffer, so that it is not necessary to keep increasing the number of buffers for the queue architecture, and thus we no longer waste any unnecessary memory.

2. The products produced according to the method of the present invention allows manufactures to introduce their products time-to-market easily. With the improved software program, the software of the product can be developed, modified, and changed much faster, and thus manufacturers can be first to market.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-layer structure unit for recording audio/video frame data, comprising:
a general control layer, for controlling a compression process for said audio/video frame data and managing a circular queue;
a task control layer, having a plurality of control units, and saving said circular queue to execute a task of said recorded audio/video frame data; and
a movie-format control layer, having at least one movie-format control unit, for creating a file by said audio/video frame data.

2. The multi-layer structure unit for recording audio/video frame data of claim 1, wherein said general control layer further comprises a circular queue management unit, a compressing image unit and a compressing sound unit.

3. The multi-layer structure unit for recording audio/video frame data of claim 1, wherein said circular queue is controlled by a head index and a tail index.

4. The multi-layer structure unit for recording audio/video frame data of claim 1, wherein said circular queue includes a plurality of buffers for storing data temporarily.

5. The multi-layer structure unit for recording audio/video frame data of claim 4, wherein said buffers have a uniform memory space.

6. The multi-layer structure unit for recording audio/video frame data of claim 4, wherein said buffers come with a status selected from the collection of a blank status, a write-in status, a fill-up status, and a read status.

7. The multi-layer structure unit for recording audio/video frame data of claim 1, wherein said control unit is an image compression task unit, a write file task unit, a sound read task unit or an application program open unit.

8. The multi-layer structure unit for recording audio/video frame data of claim 1, wherein said MOV file format control unit is an AVI file format control unit or a MOV file format control unit.

9. The multi-layer structure unit for recording audio/video frame data of claim 1, wherein said task control layer and said movie-format control layer are independent modules.

10. A method for operating a multi-layer structure unit for recording audio/video frame data, comprising the steps of:
receiving an audio/video frame data;
executing a task of compressing an audio/video frame data which is set to a blank status of a buffer in a circular queue to a write status, and compressing said audio/video frame data into said buffer;
determining whether or not said buffer is filled up;
setting the status of said buffer to a fill-up status and setting the status of another buffer to a blank status, if said buffer is determined to be filled up;
setting said buffer to a read status, after a write file task is used to detect said buffer which has been set to a fill-up status; and
reading a plurality of compressed audio/video frame data temporarily stored in said buffer and creating a movie-format file by said compressed audio/video frame data.

11. The method for operating a multi-layer structure unit for recording audio/video frame data of claim 10, wherein said task of compressing said audio/video frame data is carried out by an interlace compression method.

12. The method for operating a multi-layer structure unit for recording audio/video frame data of claim 11, wherein said interlace compression method is carried out by compressing images first and then compressing sounds.

13. The method for operating a multi-layer structure unit for recording audio/video frame data of claim 10, wherein said circular queue is controlled by a head index and a tail index.

14. The method for operating a multi-layer structure unit for recording audio/video frame data of claim 13, wherein said head index is operated and used when said write file task is executed, and said tail index is operated and used when said compress audio/video frame data task is executed.

15. The method for operating a multi-layer structure unit for recording audio/video frame data of claim 10, wherein said circular queue includes a plurality of buffers.

16. The method for operating a multi-layer structure unit for recording audio/video frame data of claim 15, wherein said buffers have a uniform memory space.

17. The method for operating a multi-layer structure unit for recording audio/video frame data of claim 10, wherein said movie-format is in an AVI file format or a MOV file format.

18. A method for a task of compressing an audio/video frame data, being an interlace compression method, applied to a method for operating a multi-layer structure unit for recording audio/video frame data, comprising the steps of:
(a) waiting for an image change event;
(b) determining whether or not said multi-layer structure unit is situated at a recording status;
(c) determining whether or not a buffer in a circular queue exists in an image frame data, if the result of Step (b) is yes;
(d) compressing a sound frame data, if the result of Step (c) is yes;
(e) determining whether or not said buffer is filled up;
(f) setting said buffer to a fill-up status, and obtaining a buffer which is set to a blank status, if the result of Step (e) is yes;
(g) setting the size for said sound frame data, if the result of Step (c) is no, or the result of Step (e) is no, or after Step (f);
(h) compressing an image frame data; and
(i) updating a recording information;
repeating the foregoing steps to compress said image frame data and said sound frame data into said buffer, so as to complete said interlace compression method.

19. The method for a task of compressing audio/video frame data of claim 18, wherein said interlace compression method is carried out by compressing images first and then compressing sounds.

20. The method for a task of compressing audio/video frame data of claim 18, wherein said image change event is an image change detected by a charge-coupled device (CCD).

21. The method for a task of compressing audio/video frame data of claim 18, wherein said circular queue includes a plurality of buffers.

22. The method for a task of compressing audio/video frame data of claim 21, wherein said buffers have a uniform memory space.

23. The method for a task of compressing audio/video frame data of claim 18, wherein said recording information is an information of a remaining recording time or a recording error.
